(19) United States
(12) Patent Application Publication
(10) Pub. No.: US 2014/0019895 A1
(43) Pub. Date: Jan. 16, 2014

(54) ELECTRONIC DEVICE

(71) Applicant: Hiroaki Honda, Yokohama-shi (JP)

(72) Inventor: Hiroaki Honda, Yokohama-shi (JP)

(73) Assignee: KYOCERA CORPORATION, Kyoto-shi, Kyoto (JP)

(21) Appl. No.: 14/008,491

(22) PCT Filed: Mar. 28, 2012
(86) PCT No.: PCT/JP2012/058228

§ 371 Date: Sep. 27, 2013

(30) Foreign Application Priority Data
Mar. 29, 2011 (JP) 2011-073515

(51) Int. Cl. G06F 3/0488

(52) U.S. Cl. CPC G06F 3/0488
USPC 715/765

(57) ABSTRACT

An electronic device according to the present invention includes a display module, a touch panel, and a control module that controls display of the display module in accordance with an operation of the touch panel. When a predetermined operation is performed to the touch panel, the control module transfers, on a display screen of the display module, an image to cause the electronic device to execute a predetermined function. When the image is transferred on the display screen, if an identical image to the image is included in the display screen, the control module performs processing of informing to that effect. The display module can display a screen for selection to select an operation screen in which the image is to be set from a plurality of operation screens, and the screen for selection includes a plurality of thumbnails corresponding to the plurality of operation screens, respectively.

### TECHNICAL FIELD

The present invention relates to an electronic device in which operating a touch panel enables setting of a shortcut of an application and a widget to be performed.

### BACKGROUND ART

In recent years, in a portable communication field, a portable terminal called a smartphone has been widespread. The smartphone has a communication function through a public telephone network or wireless LAN, a transmission/reception function of electronic mails, a connection function to the Internet, a shooting/reproduction function of still images and moving images, a creation/editing function of document files, various accessory functions, and the like.

Furthermore, the smartphone is configured so as to be able to add a new function by downloading an application (software) through the Internet or the like. In the smartphone, a touch panel is provided on a display surface of a display module, and employing a graphical user interface (GUI) allows an operation and input corresponding to the above-described diversified functions to be implemented.

In a general smartphone, a desktop screen is displayed as a main operation screen. Normally, in the desktop screen, in addition to a status bar indicating an operation status of the smartphone, icons corresponding to applications related to the above-described functions, and icons corresponding to downloaded applications are included. In order to enable a user to easily use an application selected from many applications, the smartphone is configured so that a plurality of desktop screens are switched and displayed, and the user can freely set and edit types, places and the like of the icons included in the respective desktop screens.

In the general smartphone, a menu screen is displayed in place of the desktop screen. The menu screen shows a table of the applications that the smartphone can execute, and each of the applications is displayed as the icon. Since the many icons are included, the displayed icons are replaced by module of a scroll bar operation and flick operation on the general menu screen. A shortcut icon of the icon (i.e., the application) included in the menu screen is created to be arranged on the desired desktop screen, by which the icon is added to the desktop screen.

Moreover, on each of the desktop screens of the general smartphone, in addition to the foregoing icons, one or a plurality of widgets can also be arranged. The widget is a display area (a window) corresponding to or related to an application resident in a memory at the time of display of the desktop screen, and for example, an application having a relatively small storage capacity such as a clock, a calculator, weather information, real-time display of stock information and the like. The widget is arranged on each of the desktop screens. When a user arranges the widget on the desktop screen newly, a screen indicating a table of the widgets is called, and the widget to be added to the desktop screen is selected.

A situation may happen where the user tries to set or add the shortcut icon or the widget on one of the desktop screens, which shortcut icon or widget has been already arranged on the desktop screen. The user may consciously arrange the shortcut icon of the same application or the same widget on the desktop screen so as to be overlapped. However, inmost cases, such overlap setting or arrangement is caused by the user's carelessness or forgetting, and is undesired for the user. In the conventional smartphone, no consideration has been given to the overlap arrangement of the shortcut icon or the widget on the desktop screen.

Thus, it has been desired that in the electronic device in which the touch panel can be operated to thereby perform the setting of the image to cause the electronic device to execute a predetermined function such as the shortcut of the application, the widget and the like, the undesired overlap setting for the user can be prevented.

### SUMMARY OF THE INVENTION

An electronic device according to one aspect of the present invention is an electronic device including:
a display module;
a touch panel disposed in the display module; and
a control module configured to control display of the display module in accordance with an operation of the touch panel,
wherein the display module displays an image to cause the electronic device to execute predetermined processing, and the control module transfers the image in accordance with the operation to the touch panel, and
when the image is transferred on the display screen, if a same image as the image is included in the display screen, the control module performs processing of informing to that effect.

### BRIEF DESCRIPTION OF THE DRAWINGS

FIG. 1 is a block diagram showing an outline of a smartphone according to one embodiment of the present invention.

FIG. 2 is a front view of the smartphone according to the one embodiment of the present invention, showing a state where a desktop screen is displayed.

FIG. 3 is a front view of the smartphone according to the one embodiment of the present invention, showing a state where a menu screen is displayed.

FIG. 4 is a flowchart showing shortcut setting processing according to the one embodiment of the present invention.

FIG. 5 is a front view of the smartphone according to the one embodiment of the present invention, showing a state where a desktop selection screen is displayed.

FIG. 6 is a front view of the smartphone according to the one embodiment of the present invention, showing a state where a desktop screen is selected on the desktop selection screen.

FIG. 7 is a front view of the smartphone according to the one embodiment of the present invention, showing a state where overlap of a shortcut is informed.

FIGS. 8(a) and 8(b) are explanatory views each showing a shortcut icon in a display form informing the overlap of the shortcut according to the one embodiment of the present invention.

FIG. 9 is a flowchart showing a second embodiment of the shortcut setting processing according to the one embodiment of the present invention.

FIG. 10 is a front view of the smartphone according to the one embodiment of the present invention, showing a state where the desktop screen is displayed.

FIG. 11 is a flowchart showing a third embodiment of the shortcut setting processing according to the one embodiment of the present invention.

FIG. 12 is a front view of the smartphone according to the one embodiment of the present invention, showing a state where overlap of the shortcut is informed.

FIG. 13 is an explanatory view showing a desktop screen of a smartphone according to a second embodiment of the present invention.

FIG. 14 is an explanatory view showing a desktop selection screen of the smartphone according to the second embodiment of the present invention.

FIG. 15 is an explanatory view showing the desktop selection screen of the smartphone according to the second embodiment of the present invention.

### DETAILED DESCRIPTION OF EMBODIMENTS

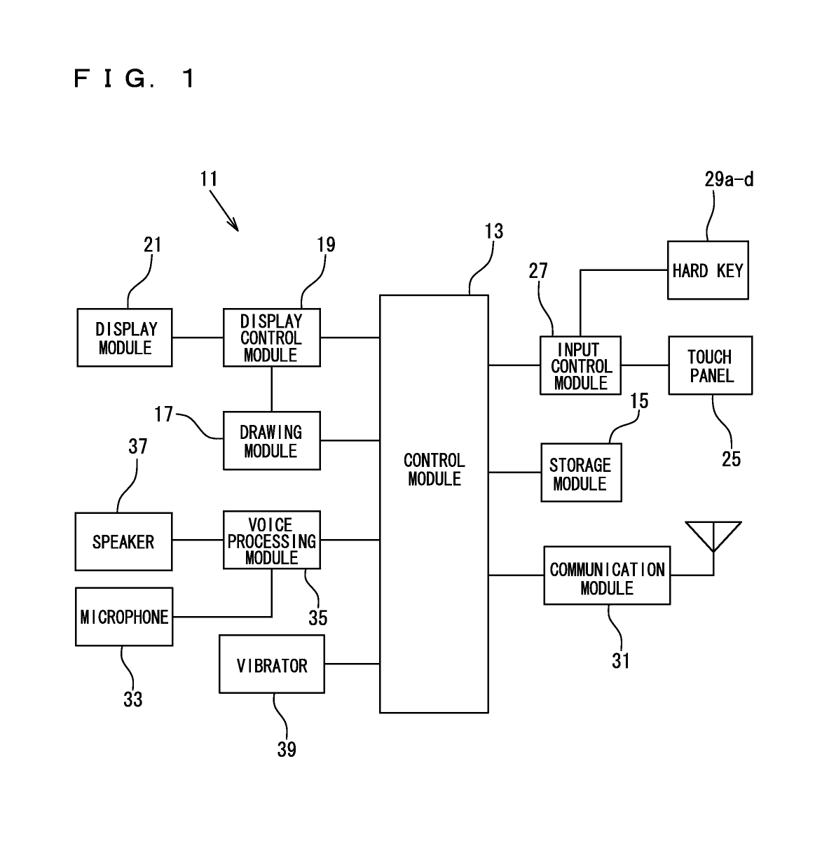

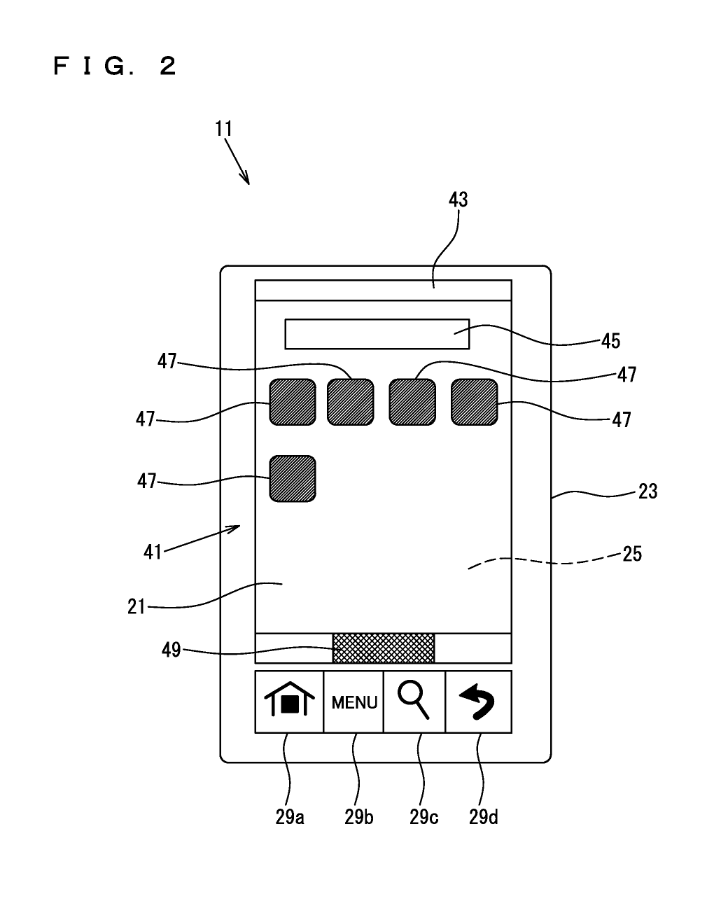

Hereinafter, one example of the present invention will be described in detail with reference to the drawings. FIG. 1 is a block diagram showing an outline of a smartphone 11, which is the one example of an electronic device of the present invention. FIG. 2 is a front view of the smartphone 11 in a state where a desktop screen is displayed.

A control module 13 configuring a control module according to one example of the present invention includes a CPU (not shown) that performs various types of arithmetic operation processing, and panoptically executes control of the smartphone 11. A storage module 15 configuring a storage module according to one example of the present invention includes a ROM, a RAM, a flash memory and the like (none of which is shown), and in the ROM, various programs that describe control procedures to be executed by the control module 13, and the like are stored, and in the RAM, data processed in the CPU of the control module 13 and the like are temporarily stored. In the flash memory, data of components of the various applications and screens (e.g., data of icons, buttons and background) and the like are stored. The control module 13 and the storage module 15 function as a computer in the smartphone 11.

A drawing module 17 synthesizes the data of the components of each of the screens stored in the storage module 15 to generate screen data, based on an instruction of the control module 13. The generated screen data is stored in a VRAM of a display control module 19. The display control module 19 displays the screen or image in a display module 21 configuring a display module according to one example of the present invention, based on the screen data or image data stored in the VRAM. The display module 21 is, for example, a liquid crystal display device, and is housed in a housing 23 so as to be visible from an opening provided in a front surface of the housing 23, as shown in FIG. 1.

The smartphone 11 includes a touch panel 25 and hard keys (29a to 29d) as an input or operation module. The touch panel 25 is, for example, an electrostatic capacitance type touch panel, and is overlapped on a display surface of the display module 21 so as to close the opening of the housing 23. When the touch panel 25 is touched by a user, an analog signal in accordance with a touch position is outputted to an input control module 27. The input control module 27 processes the analog signal transmitted from the touch panel 25, and transmits a touch position signal indicating the touch position in the touch panel 25 to the control module 13.

In FIG. 2, the four hard keys 29a to 29d provided in the front surface of the housing 23, that is, a home key 29a, a menu key 29b, a search key 29c and a back key 29d are shown. The home key 29a is used, for example, to display a desktop screen on the display module 21. The menu key 29b is used, for example, to display a submenu in the display module 21 at the time of execution of the application. The search key 29c is used, for example, to display a search screen for use in search through the Internet. The back key 29d is used to return the display screen of the display module 21 to the last display screen or the previous display screen. When one of the four hard keys 29a to 29d is pressed or when a hard key whose illustration is omitted (e.g., a power key) is pressed, the input control module 27 transmits a signal indicating the pressing to the control module 13.

A communication module 31 is connected to an antenna, and performs processing necessary for communication between the smartphone 11 and a base station of a public telephone network or an access point of wireless LAN (e.g., modulation/demodulation processing of transmitted/received data), based on an instruction transmitted from the control module 13.

A microphone 33, for example, converts voice of the user to an analog voice signal to transmit the same to a voice processing module 35. The voice processing module 35 digitalizes the voice signal transmitted from the microphone 33 to transmit the signal to the control module 13. Moreover, the voice processing module 35 analogizes the digital voice signal transmitted from the control module 13 to transmit the signal to a speaker 37. A vibrator 39 vibrates the smartphone 11. The vibrator 39 is driven, for example, at the time of incoming call or reception of an electronic mail, and the vibration notifies to that effect to the user.

In the smartphone 11, a plurality of desktop screens can be set, and one of these desktop screens is displayed in the display module 21. In the smartphone 11 of the present example, for example, the five desktop screens can be set or can be displayed, and as in a general smartphone, these desktop screens are composed of a central desktop screen and two desktop screens arranged on both sides, respectively. At the start time of the smartphone 11, the central desktop screen is displayed, for example. In FIG. 2, how a desktop screen 41 is displayed in the display module 21 of the smartphone 11 is shown. Leftward or rightward flick operation of the touch panel 25 switches the desktop screen 41 (only if this desktop screen 41 is not a rightmost one or a leftmost one) to the other desktop screen resulting from scroll transfer from the right side or the left side. The flick operation is an operation of touching and sweeping the touch panel 25 rapidly with a finger, a pen or the like.

In the illustrated desktop screen 41, a status bar 43, a widget 45, icons 47 and a launcher 49 are included. The status bar 43 is arranged in an uppermost portion of the desktop screen 41, and information regarding a status of the smartphone 11, for example, information regarding a communication status and a battery level is displayed. Moreover, when the touch panel 25 is drag-operated downward from the status bar 43 as a starting point, a table of items that the smartphone 11 is currently processing or the like is displayed in the display module 21. The drag operation is an operation of moving the touch position while touching the touch panel 25. The status bar 43 is arranged on all the desktop screens. The widget 45 is a display area corresponding to or related to an application resident in a memory at the time of the display of the desktop screen, and when the desktop screen 41 is displayed, the application set on the relevant screen is read out to the RAM from the flash memory of the storage module 15 to be executed by the control module 13.

On the illustrated desktop screen 41, the five icons 47 are arranged. Each of these icons 47 expresses a specific application. When the touch panel 25 is tapped (touched or contacted for a short time) on each of the icons 47, the control module 13 executes the application or a command corresponding to the relevant icon 47. A maximum number of the icons that can be arranged on one of the desktop screens varies in accordance with presence or absence of the widget and the like.

In the flash memory of the storage module 15, setting information of each of the plurality of desktop screens is stored. The setting information includes the numbers, types, places and the like of the widgets and/or the icons included in each of the desktop screens. In each of the plurality of desktop screens, at least one of the icons or the widgets can be arranged. Moreover, the desktop screen not including any widget and any icon can be set.

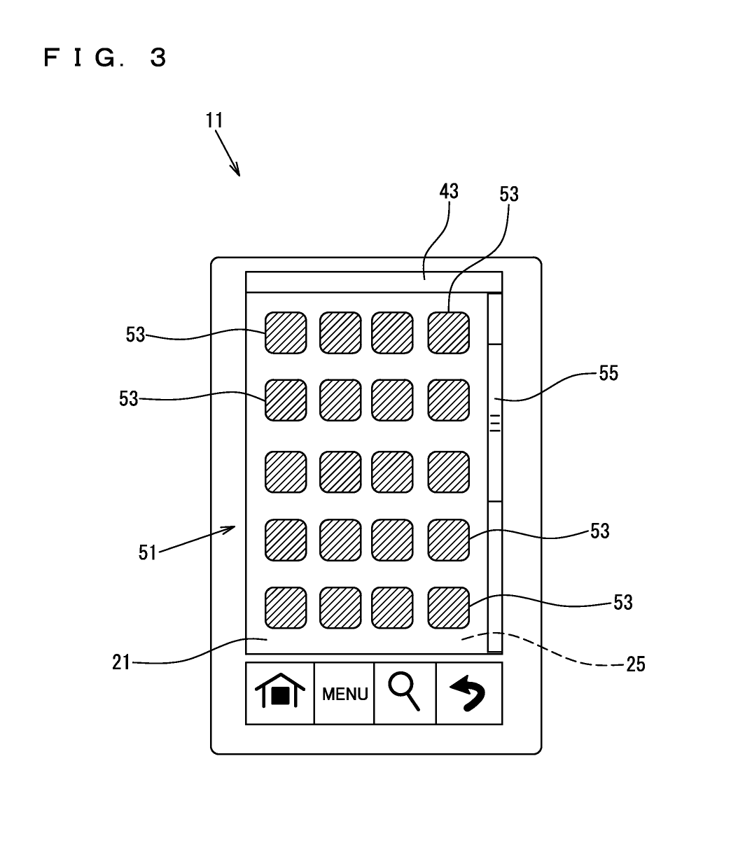

In a lowermost portion of the illustrated desktop screen 41, the launcher 49 is arranged. The launcher 49 is arranged on all the desktop screens. When the touch panel 25 is tapped on the launcher 49, a menu screen 51 as shown in FIG. 3 is displayed in the display module 21.

In the menu screen 51, the status bar 43, a plurality of icons 53 and a scroll bar 55 are included. For example, in the display module 21, up to 20 of the icons 53 are shown. The icons 53 included in the menu screen 51 are scrolled by drag-operating the touch panel 25 so as to move up and down the scroll bar 55, so that combination of the icons 53 displayed in the display module 21 is changed.

The menu screen 51 shows the user a table of the applications that the smartphone 11 can execute as the icons 53. Each of the icons included in the desktop screen, for example, the icons 47 of the desktop screen 41 shown in FIG. 2 is a shortcut icon indicating the application, and corresponds to a shortcut icon of each of the icons 53 of the menu screen 51. When the menu screen 51 is called and the specific application is selected, the shortcut icon thereof is created. The touch panel 25 is operated to select the desktop screen of a storage destination of the created shortcut icon, by which the icon (the shortcut icon) is set or stored in the desktop screen.

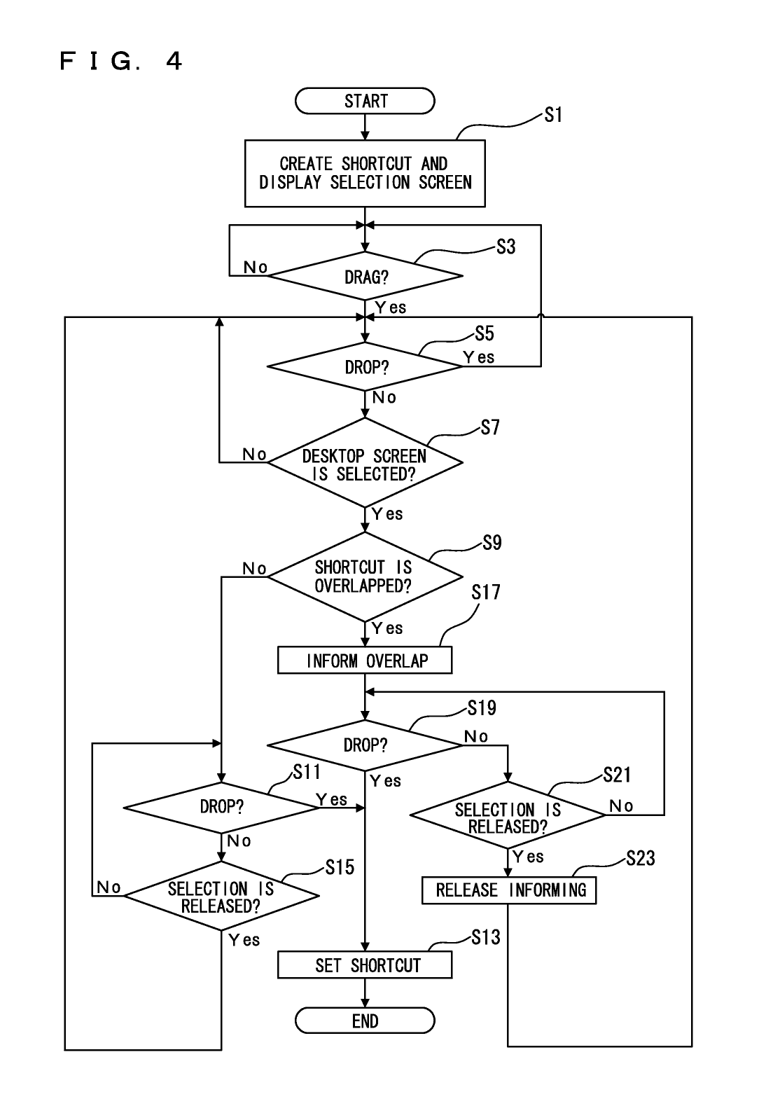

FIG. 4 is a flowchart showing shortcut setting processing according to the one example of the present invention. A program describing a procedure of this processing is stored, for example, in the ROM of the storage module 15, and is executed by the control module 13.

When in a state where the menu screen 51 is displayed in the display module 21, the touch panel 25 is long pressed (long touched) on the specific icon 53, the shortcut icon corresponding to the icon 53 is created, and a desktop selection screen is displayed in the display module 21 together with the created shortcut icon. The control module 13 identifies the icon 53 specified by the user, and determines whether or not the touch panel 25 is long pressed on the icon 53, based on the touch position signal indicating the touch position in the touch panel 25, the touch position signal being transmitted from the input control module 27, and a duration thereof, and if it is determined that the specific icon 53 is specified or selected, the control module 13 creates the shortcut icon to store the data thereof in the storage module 15, and instructs a drawing module 17 to display, in the display module 21, the desktop selection screen where the shortcut icon is arranged.

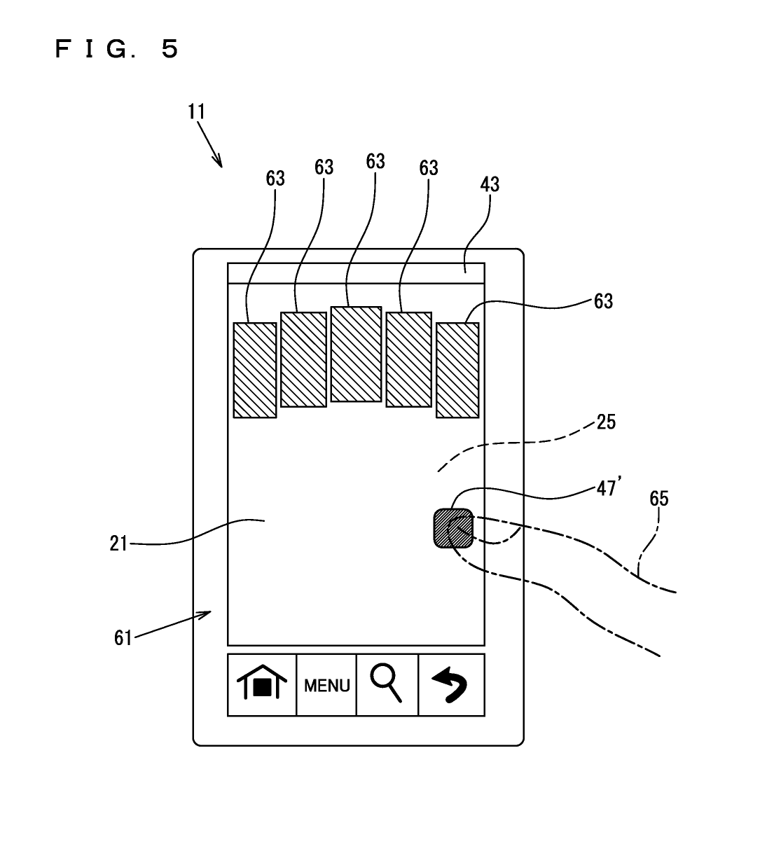

For example, when in the state where the menu screen 51 shown in FIG. 3 is displayed, the touch panel 25 is long pressed on the fourth icon 53 from the top in a rightmost row, a desktop selection screen 61 shown in FIG. 5 is displayed in the display module 21. In the desktop selection screen 61, in addition to the status bar 43, a created shortcut icon 47′ and thumbnails 63 of the desktop screens, that is, reduced images are included. Since in the smartphone 11 of the present example, the five desktop screens can be set, the five thumbnails 63 corresponding to these five desktop screens, respectively are arranged in FIG. 5. In the display module 21, the shortcut icon 47′ is displayed at the same position as that of the icon 53 selected on the menu screen 51. Therefore, on the desktop selection screen 61, the shortcut icon 47′ is arranged under a finger 65 of the user that has performed long pressing.

After step S1, the control module 13 determines whether or not the drag operation is performed with the shortcut icon as a starting point, based on the touch position signal transmitted from the input control module 27 (S3). If it is determined that the drag operation is performed, the control module 13 instructs the drawing module 17 to transfer the shortcut icon on the desktop selection screen 61 so as to match the touch position.

After step S3, the control module 13 determines whether or not drop operation is performed by the user (S5). The drop operation is an operation of releasing a touch to the touch panel 25. When the transmission of the touch position signal from the input control module 27 stops (or when the touch position signal indicates that the touch panel 25 is not touched), the control module 13 determines that the drop operation is performed. If in step S5, it is determined that the drop operation is performed, step S3 is executed.

If in step S5, it is not determined that the drop operation is performed, the control module 13 determines whether or not any of the desktop screens is selected (S7). For example, when a center of the shortcut icon is put into a predetermined area including a center of the thumbnail 63 corresponding to one of the desktop screens, the relevant desktop screen is identified as the selected screen. If in step S7, it is not determined that any of the desktop screens is selected, step S5 is executed.

If in step S7, it is determined that any of the desktop screens is selected, the control module 13 determines whether or not an icon (a shortcut icon) associated with or indicating the same application as the shortcut icon of the desktop selection screen 61 is included in the selected desktop screen with reference to information of the selected desktop screen stored in the storage module 15 (S9). In step S9, whether or not a pattern of the icon is the same is not determined, but whether or not the application indicated by the icon or the application corresponding to the icon is the same is determined. In step S9, whether or not the pattern of the icon is the same may be also a determination reference.

If in step S9, it is not determined that the icon associated with or indicating the same application as the shortcut icon of the desktop selection screen 61 is included in the selected desktop screen, the control module 13 determines whether or not the drop operation is performed by the user (S11). If in step S11, it is determined that the drop operation is performed, the control module 13 updates information of the selected desktop screen, which information is stored in the storage module 15, and stores or sets the shortcut icon in the desktop screen (S13). If in step S11, it is not determined that the drop operation is performed by the user, the control module 13 determines whether or not the selection of the desktop screen is released (S15). If in step S15, it is determined that the selection of the desktop screen is released, step S5 is executed. If it is not determined that the selection of the desktop screen is released, step S11 is executed.

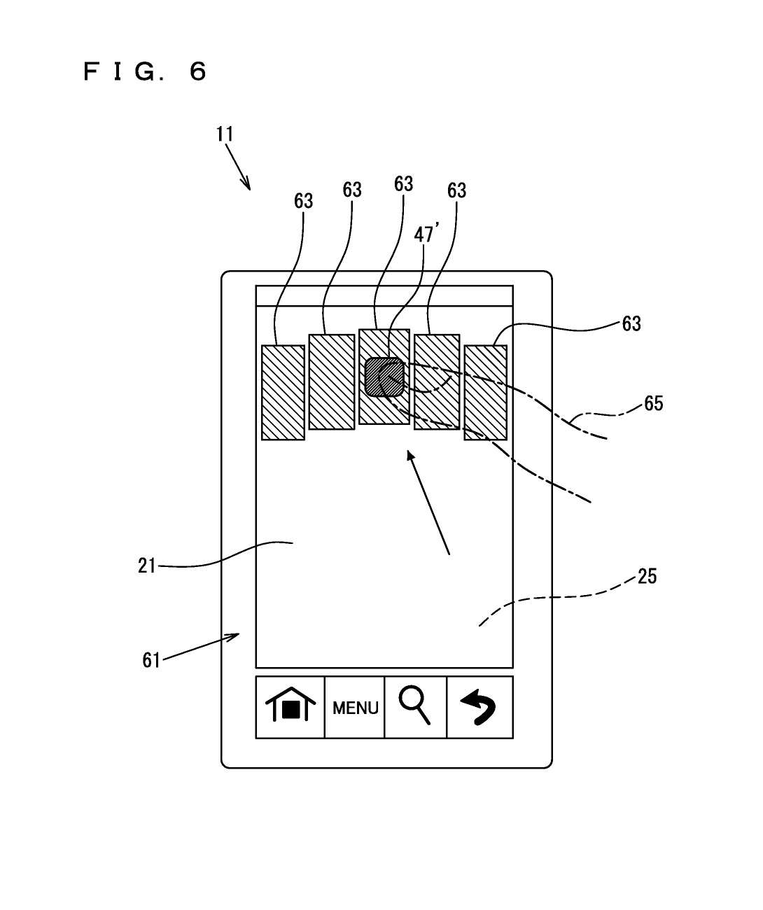

For example, when step S1 is executed, the desktop selection screen 61 shown in FIG. 5 is displayed in the display module 21. FIG. 6 shows how the shortcut icon 47′ is transferred by the drag operation of the touch panel 25 from the position shown in FIG. 5 to a center of the thumbnail 63 arranged in the middle on the desktop selection screen 61, so that the desktop screen corresponding to the thumbnail 63 is selected. FIG. 6 shows the desktop selection screen 61 in the case where the icon associated with or indicating the same application as the shortcut icon 47′ is not included in the selected desktop screen. When in a state shown in FIG. 6, the drop operation is performed, step S13 is executed, and the shortcut icon 47′ is set or stored in the desktop screen corresponding to the thumbnail 63 in the middle.

If in step S9, it is determined that the icon associated with or indicating the same application as the shortcut icon of the desktop selection screen 61 is included in the selected desktop screen, that is, if it is determined that when the shortcut icon of the desktop selection screen 61 is stored in the selected desktop screen, the icons associated with or indicating the same application are overlapped, the control module 13 performs processing of informing or giving warning to that effect to the user (S17). In the present example, in step S17, the control module 13 instructs the drawing module 17 to display, in the display module 21, the thumbnail 63 corresponding to the selected desktop screen so as to visually distinguish the relevant thumbnail 63 from the other thumbnails 63.

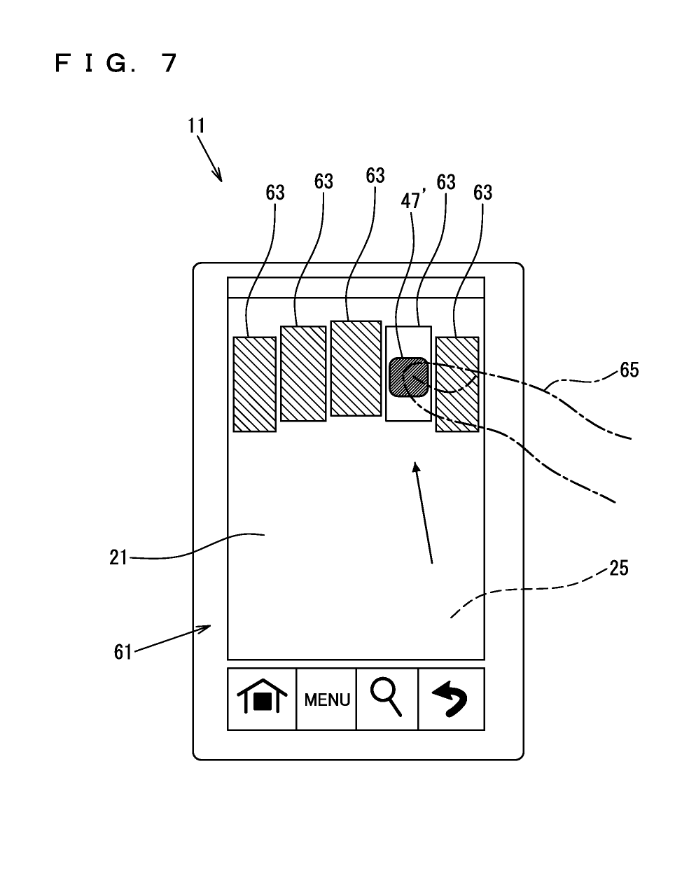

FIG. 7 shows how the shortcut icon 47′ is transferred by the drag operation of the touch panel 25 from the position shown in FIG. 5 to a center of the second thumbnail 63 from the right on the desktop selection screen 61, so that the desktop screen corresponding to the relevant thumbnail 63 is selected. Since the icon associated with or indicating the same application as the shortcut icon 47′ is included in the selected desktop screen, step S17 is executed, and the second thumbnail 63 from the right (the white thumbnail 63) is blink-displayed to inform the user of the overlap of the icon.

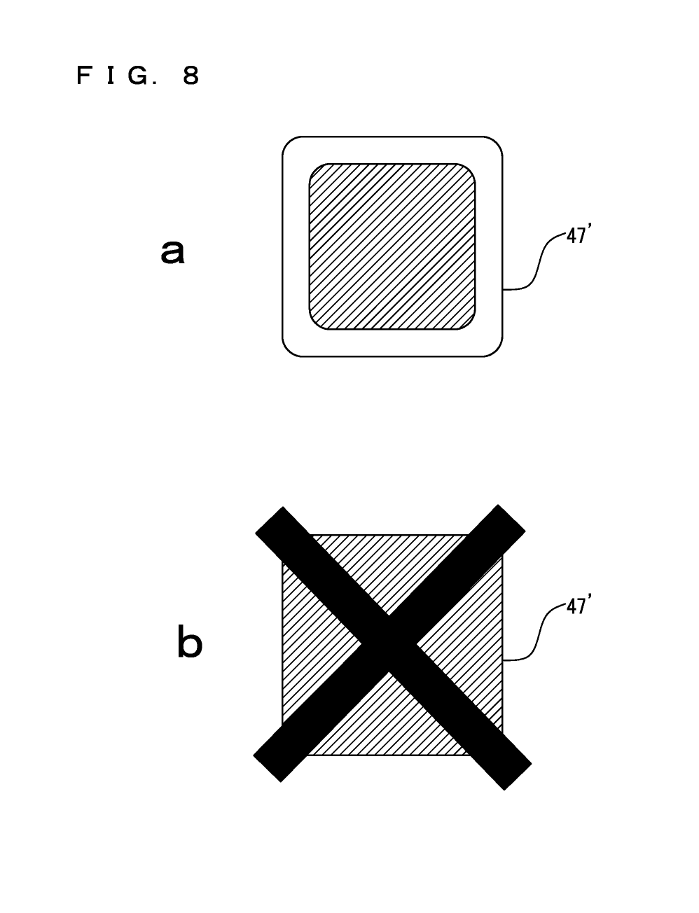

The informing in step S17 may be made by changing a display form of the shortcut icon on the desktop selection screen 61. For example, an instruction by the control module 13 to the drawing module 17 may cause an edge portion (indicated in white) of the shortcut icon 47′ to be blink-displayed as shown in FIG. 8(a), or may cause an X sign to be displayed so as to be superimposed on the shortcut icon 47′ as illustrated in FIG. 8(b).

The informing in step S17 may be made, using the speaker 37 or the vibrator 39 of the smartphone 11 in place of changing the display in the display module 21. In step S17, the control module 13 may transmit voice data of informing or warning sound to the voice processing module 35, and the informing sound, for example, beep sound may be emitted from the speaker 37. Moreover, in step S17, the control module 13 may drive the vibrator 39 to vibrate the smartphone 11.

After step S17, the control module 13 determines whether or not the drop operation is performed by the user (S19). In the present example, the overlap setting of the shortcut icons is enabled, and if in step S11, it is determined that the drop operation is performed, step S13 is also executed. If, after step S19, step S13 is executed, either the added icon or the existing icon may be deleted or erased. If in step S19, it is not determined that the drop operation is performed by the user, step S21 similar to step S15 is performed. If in step S21, it is determined that the selection of the desktop screen is released, the control module 13 releases the informing, that is, ends the processing executed in step S17 (S23). After step S23, step S5 is executed. Moreover, if in step S21, it is not determined that the selection of the desktop screen is released, step S19 is executed.

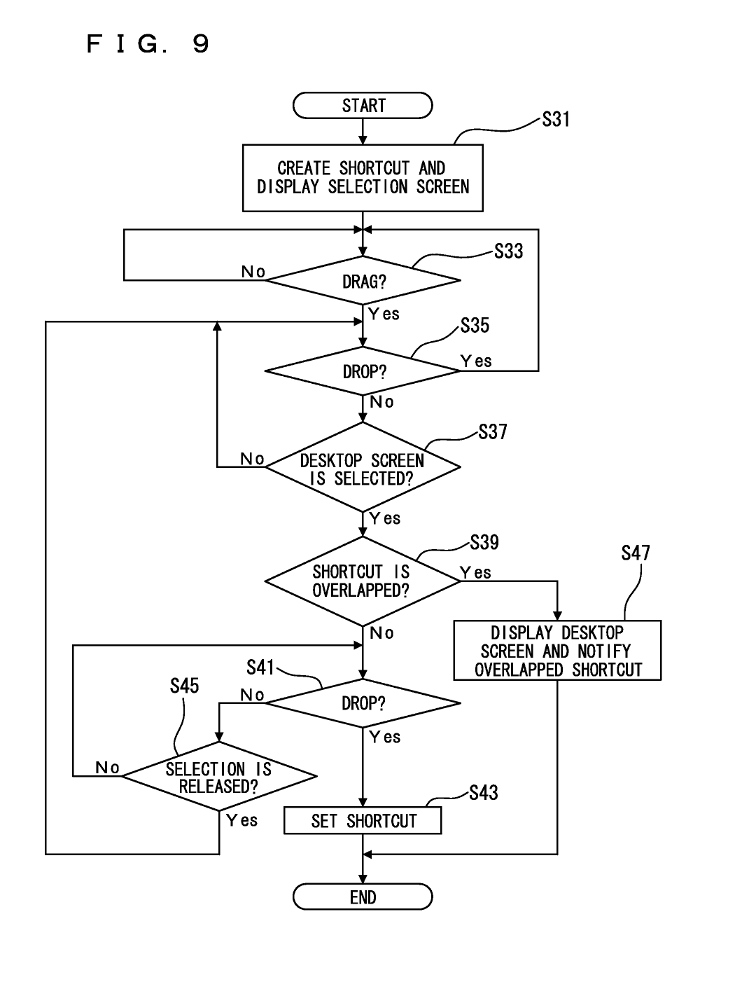

FIG. 9 is a flowchart showing a second embodiment of the shortcut setting processing according to the one example of the present invention. Steps S31 to S45 shown in FIG. 9 correspond to steps S1 to S15 shown in FIG. 4, respectively, and thus, a description thereof is omitted.

If in step S39, it is determined that the icon associated with or indicating the same application as the shortcut icon of the desktop selection screen 61 is included in the selected desktop screen, the control module 13 instructs the drawing module 17 to display the relevant desktop screen in the display module 21 (S47). In step S47, the overlapped icon arranged or stored in the selected desktop screen is displayed so as to be visually distinguished from the other icons on the relevant desktop screen. This enables the user to instantly understand which icon is overlapped.

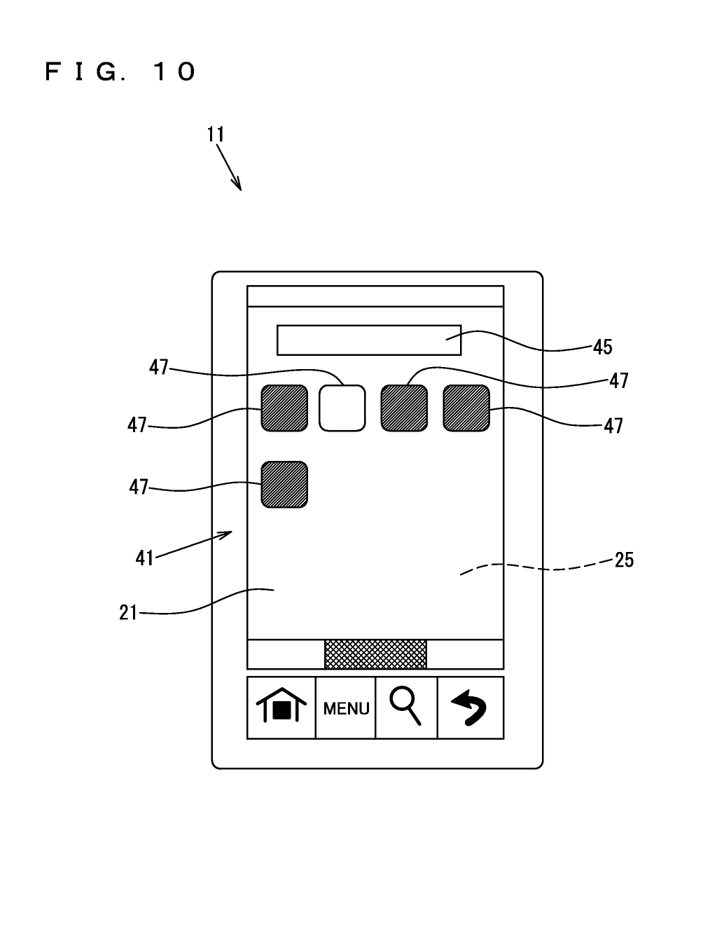

For example, if when the desktop screen 41 illustrated in FIG. 2 is selected in step S37 and the icon corresponding to the same application as the shortcut icon created in step S31 is the second icon 47 from the left in an upper line on the desktop screen 41, step S47 is executed, then the desktop screen 41 as shown in FIG. 10 is displayed in the display module 21. The second icon 47 from the left in the left row (indicated in white) is blink-displayed to be visually distinguished from other icons 47. The second icon 47 from the left in the left row may be displayed as described in FIGS. 8(a) and 8(b)

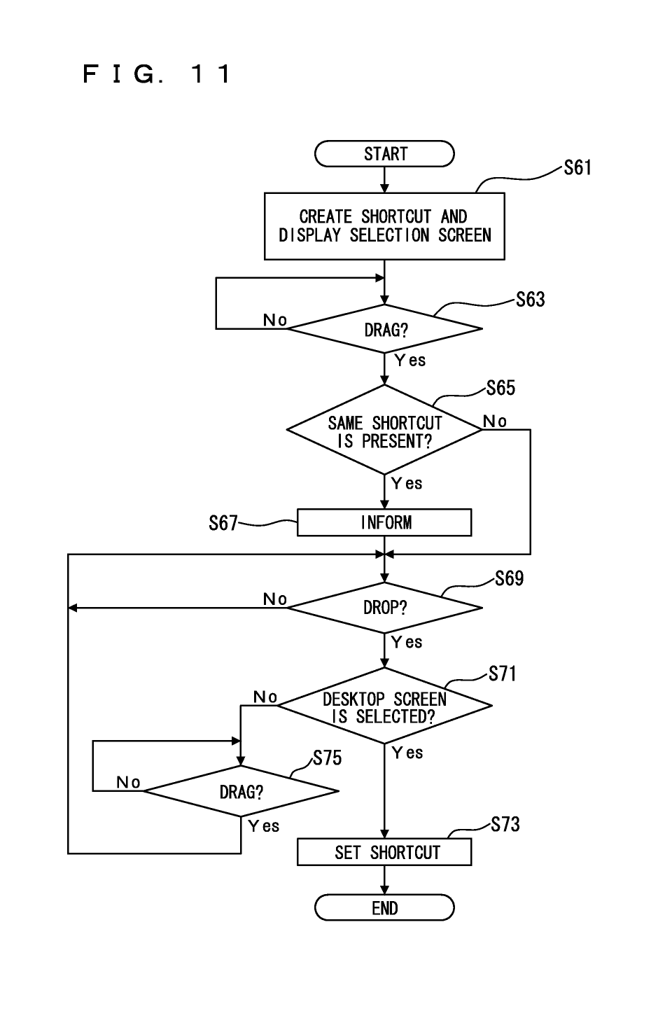

FIG. 11 is a flowchart showing a third embodiment of the shortcut setting processing according to the one example of the present invention. Steps S61 and S63 in FIG. 11 correspond to steps S1 and S3 in FIG. 4, respectively. In the third embodiment shown in FIG. 11, if in step S63, it is determined that the drag operation is performed to the created shortcut icon, the control module 13 determines whether or not the same shortcut icon as the created shortcut icon is included in the desktop selection screen (S65). If in step S65, it is determined that the same shortcut icon is included in the desktop selection screen, the control module 13 performs processing of informing or giving warning to that effect to the user (S67).

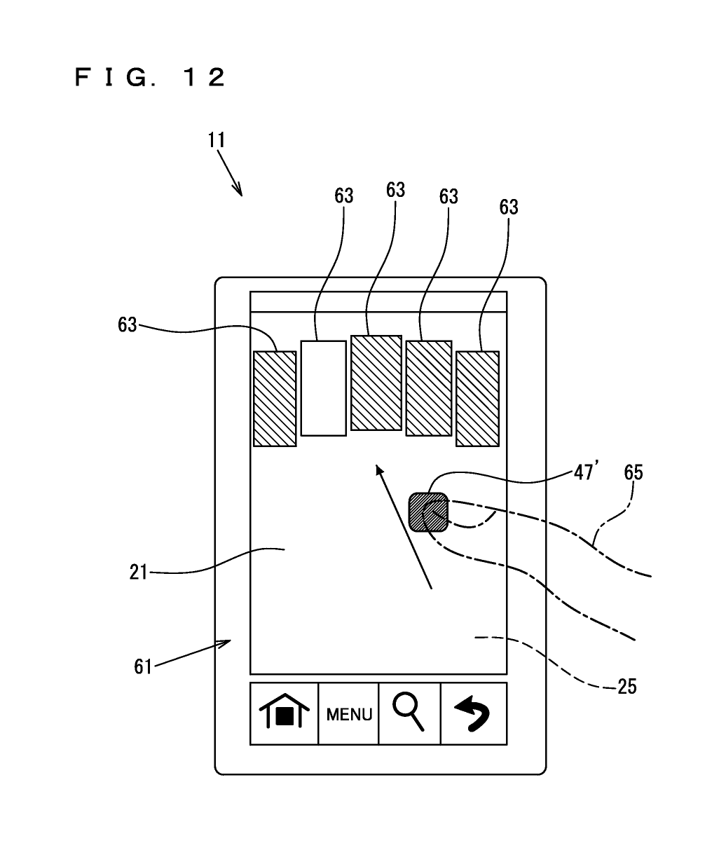

When step S61 is executed to display the desktop selection screen 61 as shown in FIG. 5 in the display module 21, and in step S63, it is determined that the drag operation is performed to the shortcut icon 47′, so that the shortcut icon 47′ is transferred on the desktop selection screen 61, in step S65, it is determined whether or not the same shortcut icon as the shortcut icon 47′ is included in the desktop selection screen 61. Each of the thumbnails 63 is a reduced image of the corresponding desktop screen, and in each of the thumbnails 63, the shortcut icons stored in the corresponding desktop screen are reduced and drawn. For example, in the thumbnail 63 corresponding to the desktop screen 41 illustrated in FIG. 2, reduced images of the five shortcut icons 47 shown in FIG. 2 are also included. For example, when the same shortcut icon 47 as the shortcut icon 47′ is included in the second thumbnail 63 from the left shown in FIG. 5, execution of step S67 causes the second thumbnail 63 from the left (indicated in white) to be blink-displayed and be visually distinguished from the other thumbnails 63 as shown in FIG. 12. In step S67, methods other than the blink display of the thumbnail 63 as described before may be used to inform the user.

After step S67, the control module 13 determines whether or not the drop operation is performed (S69), and if it is determined that the drop operation is performed, as in step S7 in FIG. 4, the control module 13 determines whether or not any of the desktop screens is selected (S71). If in step S71, it is determined that the desktop screens is selected, the control module 13 executes step S73 corresponding to step S13 in FIG. 4. If in step S71, it is not determined that the desktop screen is selected, the control module 13 determines whether or not the drag operation to the shortcut icon created in step S61 is performed again (S75). If in step S75, it is determined that the drag operation is performed, the control module 13 executes step S69.

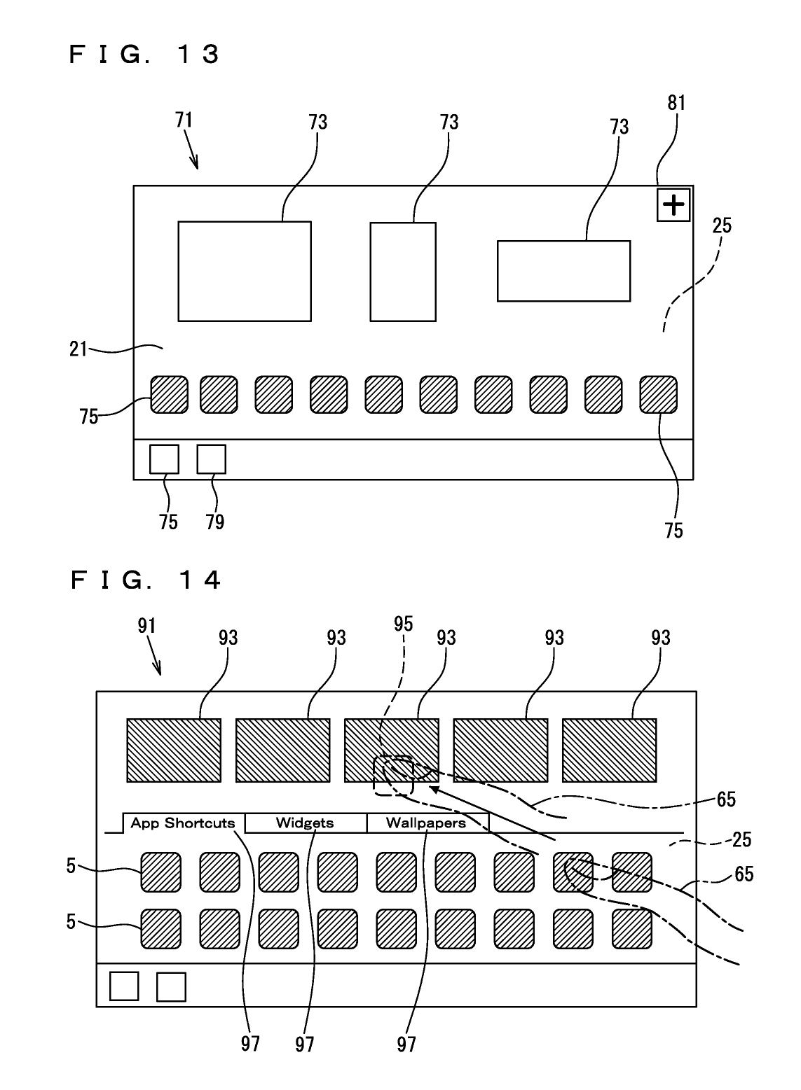

The present invention can be used not only for the shortcut creation of the application but also for widget setting of the desktop screen. While a smartphone of a second example of the present invention has a configuration similar to that of FIG. 1, it is a so-called tablet smartphone. FIG. 13 is an explanatory view showing how in the smartphone of the second example, a desktop screen 71 is displayed in the display module 21 (it should be noted that in FIGS. 13 to 15, the whole smartphone is not illustrated).

The desktop screen 71 includes widgets 73, icons 75, a back button 77, a home button 79 and a desktop selection screen display button 81. While in FIG. 13, the three widgets 73 and the ten icons 75 are shown, as described before, in one embodiment of the present invention, the numbers of the widgets and the icons included in each of the desktop selection screens are not particularly limited. In the second example, the five desktop selection screens can be set as in the first example, and the flick operation of the touch panel 25 switches the desktop selection screen to be displayed in the display module 21.

The back button 77 is used to return the display screen of the display module 21 to the previous display screen. The home button 79 is used to display the menu screen. The desktop selection screen display button 81 is used to display the desktop selection screen.

In FIG. 14, how the touch panel 25 is tapped on the desktop selection screen display button 81 to display a desktop selection screen 91 in the display module 21. In a substantially upper half of the desktop selection screen 91, five thumbnails 93 corresponding to the five desktop selections similar to FIG. 5, respectively are arranged. In a substantially lower half of the desktop selection screen 91, a plurality of shortcut icons 95 of applications are arranged. The shortcut icons 95 displayed on the desktop selection screen 91 are scrolled by the flick operation of the touch panel 25 to thereby be replaced. As in the first example, the shortcut icon 95 is selected by being long pressed with the finger 65, and the touch panel 25 is drag-and-drop-operated to arrange the selected shortcut icon 95 in a central area of the thumbnail 93, by which the shortcut icon 95 is set in or added to the desktop screen corresponding to the relevant thumbnail 93.

In the smartphone of the second example as well, the informing or notification of the overlapped icon as described in the first example is executed. Those in the art could easily understand that the shortcut setting processing of the one embodiment according to the present invention, which has been described in the flowchart shown in FIG. 4, 9 or 11, can also be easily applied to the smartphone of the second example.

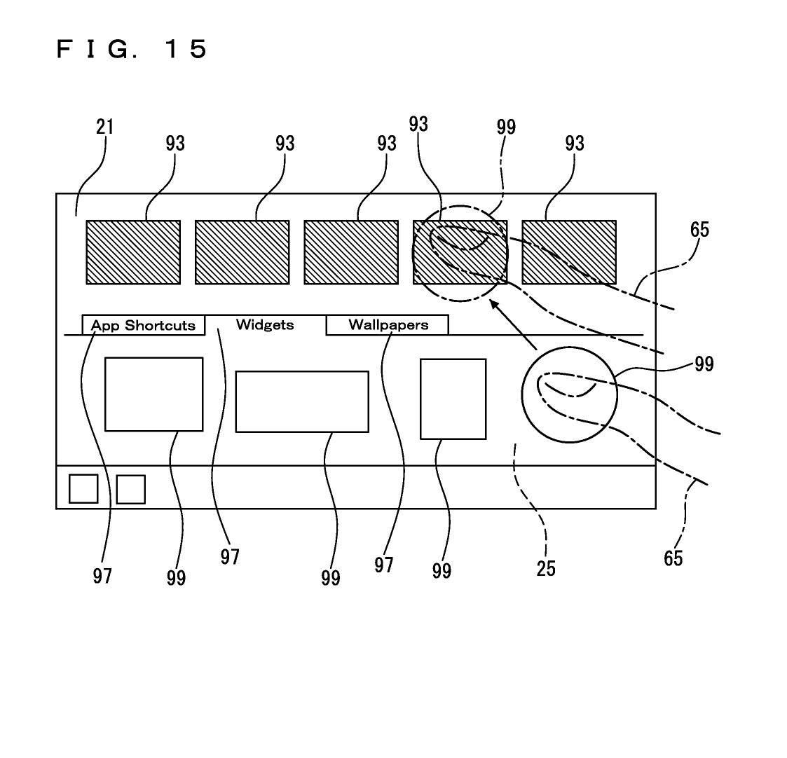

The desktop selection screen display button 81 is provided with several tabs 97. Tapping the touch panel 25 on the tab (“Widgets”) in the middle of the three tabs 97 switches the desktop selection screen 91 to a widget setting mode, as shown in FIG. 15. Tapping the touch panel 25 on the left tab (“App Shortcuts”) of the three tabs 97 in this state switches the desktop selection screen 91 to a shortcut setting mode shown in FIG. 14.

In the widget setting mode shown in FIG. 15, the five thumbnails 93 are also arranged in the substantially upper half of the desktop selection screen 91. In the substantially lower half of the desktop selection screen 91, icons (widget icons) 99 corresponding to the widgets or indicating the widgets are arranged. The icons 99 displayed on the desktop selection screen 91 are scrolled by the flick operation of the touch panel 25 to thereby be replaced. As in the icon setting processing of the first example, the icon 99 is selected by being long pressed with the finger 65, and the touch panel 25 is drag-and-drop-operated to arrange the selected icon 99 in a central area of the thumbnail 93, by which the widget 73 corresponding to the icon 99 is set in or added to the desktop screen corresponding to the relevant thumbnail 93.

In the smartphone of the second example, similar to the shortcut icon indicating the application, informing or notification of the overlapped widget is executed. Those in the art could easily understand that the shortcut setting processing of the one embodiment according to the present invention, which has been described in the flowchart shown in FIG. 4, 9 or 11 can also be easily applied to widget setting processing in the smartphone of the second example.

While the examples in which the present invention is applied to the smartphone have been described, the present invention can also be applied to an electronic device including a touch panel other than the smartphone, for example, a portable game machine, a navigation device, a printer and the like. Moreover, the icons or the shortcuts processed according to the present invention may express, for example, document files, image files and the like.

The procedures shown in the flowcharts in FIGS. 4, 9 and 11 are merely the examples of the present invention, and the present invention may be carried out using a procedure different from the procedures shown in these flowcharts.

The above description is to describe the present invention, and should not be construed as limiting or restricting the invention described in the scope of claims. Moreover, the configurations of the respective modules of the present invention are not limited to the above-described examples, and obviously, various modifications can be made within a technical range described in the scope of claims.

DESCRIPTION OF REFERENCE CHARACTERS

11 smartphone

13 control module

15 storage module

21 display module

25 touch panel

41 desktop screen

47 shortcut icon

45 widget

47′ shortcut icon

51 menu screen

53 icon

61 desktop selection screen

63 thumbnail

73 widget

75 shortcut icon

91 desktop selection screen

93 thumbnail

95 icon

99 widget icon

1. An electronic device comprising:
a display module;
a touch panel disposed in the display module; and
a control module configured to control display of the display module in accordance with an operation of the touch panel,
wherein the display module displays an image to cause the electronic device to execute predetermined processing, and the control module transfers the image in accordance with the operation to the touch panel, and
when the image is transferred on the display screen, if a same image as the image is included in the display screen, the control module performs processing of informing to that effect.

2. The electronic device according to claim 1,
wherein the display module is capable to switch and display a plurality of operation screens, and
when the image is transferred on the operation screens, and when the same image as the image is included in the operation screen, the control module performs the processing of informing to that effect.

3. The electronic device according to claim 1,
wherein the display module is capable to switch and display a plurality of operation screens, and
the display screen is a screen for selection to select the operation screen in which the image is to be set from the plurality of operation screens, and the screen for selection includes a plurality of thumbnails corresponding to the plurality of operation screens, respectively.

4. The electronic device according to claim 3, wherein when the touch panel is operated, and the control module causes the display module to display the screen for selection.

5. The electronic device according to claim 3, wherein the informing is performed by displaying, in the display module, the thumbnail corresponding to the operation screen including an identical image to the image so as to distinguish the same from the other thumbnails.

6. The electronic device according to claim 1, wherein the image is a shortcut icon or a widget.

7-8. (canceled)

9. An electronic device comprising:
a display module;
a touch panel disposed in the display module; and
a control module configured to control display of the display module in accordance with an operation of the touch panel,
wherein the display module displays an image indicating an application to cause the electronic device to execute predetermined processing, and the control module transfers the image indicating the application in accordance with the operation to the touch panel, and
when the image indicating the application is transferred on the display screen, if a image associated with the same application as the image indicating the application is included in the display screen, the control module performs processing of informing to that effect.
